(19) United States
(12) Patent Application Publication
(10) Pub. No.: US 2020/0042585 A1
(43) Pub. Date: Feb. 6, 2020

(54) INTERWRITING: BUILDING INDEPENDENT TEXTS WITHIN ANOTHER TEXT

(71) Applicant: Raul Martinez Rosario, Chicago, IL (US)

(72) Inventor: Raul Martinez Rosario, Chicago, IL (US)

(21) Appl. No.: 16/563,764

(22) Filed: Sep. 6, 2019

(51) Int. Cl. G06F 17/24; G06F 17/21; G06F 17/22

(52) U.S. Cl. CPC G06F 17/241; G06F 17/2217; G06F 17/218

(57) ABSTRACT

A method, called Interwriting, that builds one or more independent texts within a bigger normal text, referred to as ordinary text, by selectively highlighting or otherwise signalizing some of the words in the ordinary text. Although recycling some of the same words, the ordinary text and the signalized text, each communicates its own distinctive message without disrupting one another's content. A signalized text conveys its own distinct message only when read separately from the ordinary text that houses it.

### FIELD OF INVENTION

The present invention, Interwriting, relates to the broad field of the written word, including: advertisements, general literature, and more specifically, storytelling.

### BACKGROUND OF THE INVENTION

For interwriting, a normal written text, referred to as ordinary text, is not just what that text says or means to say, but it is also a space full of words that, still within their text, can be used to express a new message. This means that the same text, at the same time, recycling some of the same words, could offer more than one independent readings of itself, each reading with a different message. Also, an ordinary text can be written, from the beginning, so that it can display one or more independent signalized texts, each text able to communicate its own distinctive coherent message. Normally, when highlighted or signalized, a text emphasizes what it says in its signalized portions; but in an interwritten text, the signalized portions are not isolated entities, they are all orderly connected parts that, when read as a whole, convey an independent message within the ordinary text where they are signalized.

### BRIEF SUMMARY OF THE INVENTION

This invention introduces the concept of interwriting, to refer to the notion and the techniques that allow to build one or more independent texts within a normal text, referred to as ordinary text, and to communicate a different message in each text. A selective highlight or other signalization is used to create and communicate new information otherwise not expressed in the ordinary text when read normally. The signalized words convey their message when read separately from the ordinary text that houses them. Ordinary text will refer to any text, with or without signalized words, presented for a normal reading; Signalized or highlighted text will refer to only the highlighted or otherwise signalized portions of an ordinary text which, besides being integral part of that ordinary text, also conforms a text of its own. A text's signalization can be indicated either through a highlight, an underlined, a bold, a different color or font of its words or any similar signalization or combination of them that would allow a separate reading of the signalized text from the ordinary text that contains it. It is always a good idea to point at the beginning of each signalized text with an arrow or with the tip of an arrow to remind the reader of its presence in a text [symbol] One must bear in mind that to produce an independent highlighted text inside an ordinary text, all words to be signalized must be picked with precision and guided with the intention of communicating certain message. The signalized words, by themselves, must express an intended and logical discourse. In most cases, when a text is highlighted, it might be useful to format portions of the highlighted text, to line up one below the other, to give them a more unified look and make their reading easier than if they were scattered all over the page. An ordinary text and a signalized text's meeting can generate endless possibilities of contents interactions. This way, with interwriting we can begin a creative alternative way of writing from a long novel, to a greeting card or a marketing sign.

### Advantageous Effects of this Invention

(a) By introducing the interwriting concept and techniques as an alternative way of reading and writing, this invention would be enhancing the possibilities of expression through the written word, especially in very creative fields like literature and advertisement.
(b) A shorter signalized text inside a longer text would be more attractive to read for many people that would not otherwise read a long text. Including a signalized text in a reading can give the chance to turn a normal written piece into a more effective and memorable reading. Compare the content of the ordinary text and the highlighted text when they cross over in the interwriting bellow:
(c) Interwriting can build very creative, versatile and engaging texts with multiple reading capabilities. It takes great advantage of the capabilities that electronic word processors offer to handle words and texts to make them carry an extra message.
(d) Interwriting could be a powerful tool in the field of child development and education, by encouraging children to read and be more creatively engaged when reading, given that, when presented with a text by their teacher, they could not only read it, but could be directed to produce their own work within the work they are handed. Every child can come up with their own creative signalized text.
(e) Having one or more signalized texts within one ordinary text opens the door for written pieces not otherwise possible in literature or advertisement. For example: “Dominican Republic, Inexhaustible” is the motto of the Dominican Republic Secretary of Tourism. Below, the motto is included as the highlighted text of a small interwriting. Both, ordinary text and highlighted texts, complement each other. We may read the ordinary text, then just the highlighted text only. [symbol]
(f) Interwriting can greatly impact how we write a joke, a tweet or a greeting card. With this tool, more could always be said with the same number of words. Please, read the ordinary text, then each extra signalized text in the next samples:
Bill Clinton's words:
(g) Interwriting can be a very effective way of writing abstracts of very long documents (manuals, complicate contracts or legal documents, mortgage agreements or long school texts). Those abstracts can use the ordinary texts for the whole texts, while the highlighted text for just essential summaries in an easy to grasp coherent uninterrupted narrative. That narrative would not disrupt the context of the ordinary text.
(h) An interwritten piece would have, in most storytelling, built-in irony and suspense since it allows to put one story inside another. This gives the signalized text a chance to present a different version of what the ordinary text says.
(i) Continuing a story inside itself increases reader curiosity and expectation toward any interwritten work. The reader would want to find out what the unsuspected content of the signalized text in the story would have to say.
(j) An interwriting reading could be started from different perspectives: the ordinary text perspective or the signalized text perspective.
(k) Two persons with opposing views of a subject could discuss it in an interwriting; one person could write the signalized text while the other person, the ordinary text.
(l) If a written work is criticized by highlighting its own words, the reader will immediately have the critic opinion, and the original work in just one piece of writing.
(m) A portion of a novel, an old narration or of a news paper article can serve as ordinary text for a signalized short story.
(n) Interwriting can allow for an ordinary text to be read normally, from the top down, while its signalized text can be written to be read either downward or upward. An upward reading of a text would give the reader a novel experience in reading. The fallowing are two short examples of interwritten texts where the highlighted text must be read upward while the ordinary text is to be read normally, downward:
Bill Clinton's words:

### DETAILED DESCRIPTION OF THE INVENTION

Since the beginning of written word, humans have understood that if a reader jumps words or portions of words when reading a text, the reading would still say something, but something senseless or distorted. Understanding this, the interwriting technique allows for very controlled jumps within a text reading to signalized only the portions of that text that would coherently communicate a new message. That new message would be contained just in the signalized or highlighted text when given a separate reading from the ordinary text that houses it. The highlighted text's message can even present a different perspective of what was already said in the ordinary text. In other words, it would use the ordinary text's own words to put that whole existing text in another context. The highlighted or signalized text could be produced to be read downward or upward; when it is to be read upward, it needs to be indicated by an arrow pointing upward (↑) at the signalized text's beginning at the end of the ordinary text.

### The Embodiment Text

Below are the four different ways that I have developed to produce an interwriting. The main ones are a an b, and I prefer them when I have a pretty good idea of what I am going to say; and I favor c and d when I'm not sure on what to write and want to be open to any occurrence or inspiration. A combinations of some of these techniques also works:

(a) Choose portions of an ordinary text and signalize them.
(b) Choose what would be the whole signalized text first, then write an ordinary text that would embrace it.
(c) A flexible ordinary text writing
(d) Two simultaneous text writing
a) Choose portions of an ordinary text and highlight or signalize them: to produce a new message in an existing ordinary text, the ordinary text must be read carefully, understanding what it is saying, and what it can be said with its vocabulary. After this, it is recommended to visualize the effect that the tentative new message would have on the overall interwriting as a unit. At this point, any change of mind on what the highlighted text message will be can still occur. Once certain on the message that the highlighted text will convey, it is time to start communicating that new message by highlighting the portions of the ordinary text needed for the highlighted text to communicate it. The new message may start by picking from the ordinary text at hand a noun or a pronoun and highlighting it, then highlighting a corresponding verb and so forth, we have to continue highlighting in the ordinary text the phrase, sentence or sentences that would orderly complete the decided signalized text's message.

No doubt that the signalized text is very flexible in saying different things using the ordinary text's vocabulary; the following samples will show that flexibility in one ordinary text simple sentence:

b) Choose what would be the whole highlighted text first, then write an ordinary text that would embrace it: There is no better way to make sure that the highlighted text is going to say with precision what it must say than to write it and signalize it before writing the ordinary text. It does not matter if the highlighted text is a multiple pages long written piece or just a one sentence long. The highlighted text, when produced first, can guide the ordinary text to inform it on what the length of its message should be, and possibly, it would suggest what would be a good ordinary text's contrasting message to face up the highlighted text's message. This technique of producing the highlighted text first is also the less difficult way to enclose, as the highlighted text of an interwritten work, a finished document like the final part of a short story, a song, somebody else's written document or any finished piece that, for better effect of the interwriting, must be shown as a highlighted text inside an ordinary text yet to be written. To write the ordinary text that will go with the already selected highlighted text, one must have a very clear idea of what the content of the ordinary text will be, even when flexible with the words one will use to convey that message. Once this is understood, the writing of the ordinary text must take place, starting at its beginning: going over reading the beginning of the highlighted text, if this is also a good beginning for the ordinary text, it must be embraced, if not, a different beginning must be written. In either case, after the beginning, one must continue writing the ordinary text while making the highlighted text vocabulary an integral part of the ordinary text. The ordinary text must keep expressing its own content while building its own syntactic structure. This is done progressively, while fractioning the highlighted text discourse where needed. This must be done until all highlighted text is integrated into the context of the ordinary text. After this is done, the ordinary text's message can end any time. At the end, the highlighted text's words may be separated within the recent finished ordinary text lines, but their message will remain intact.

In the next sample, the entire sentence below was chosen and highlighted twice as the highlighted texts of two interwritten pieces. In each case, after highlighting the sentence, the next step was to write the ordinary text that would embrace said sentence. Note that the ordinary text on example II reads downward and so does its highlighted text; but in example III, the ordinary text reads downward while its highlighted text reads upward.

In both cases, it was necessary to decide first what to say in the ordinary text with the highlighted text text's words at hand. To construct the ordinary text's message, some content needed to be added before the highlighted text's beginning, then, as we went over reading the highlighted text's discourse, we fractioned it, inserting ordinary text's words where necessary to direct all words and meaning to convey only one message: the ordinary text's message that we had decided to communicate. The interwriting was ended with an ordinary's text final line. The result, in each case, exhibits the ordinary text's desired message while the highlighted text stays saying the same. This same technique that puts a sentence inside a short text, can put an entire short story inside another story.

And for an interwriting with two highlighted texts, let's see the example below. The technique is the same. The two highlighted texts were produced first, each with a different color to keep its message intact; then they were both treated as one, and integrated as part of an ordinary text written afterward. Once inside their ordinary text, both highlighted texts can be read as integral parts of the ordinary text, but also, because of the different color or style or their letters, each text could get a separate reading from the ordinary text that contains it

Below we find the previous two highlighted texts integrated into just one ordinary text. Each text is also available for a separate reading:

c) A flexible ordinary text writing technique: here the ordinary text writing must start while at the same time trying to use words and phrases that the highlighted text would need in its own context. Once the ordinary text is finished, all what is useful for the highlighted text must be highlighted, while adding and removing words to accommodate each text's message.
d) Two Simultaneous texts writing technique: Decide what each text would say, then start writing and at every step of the writing, an evaluation of whatever was said for the ordinary text and for the highlighted text must be done. Adjustments must also be done on the go, switching back and forth the focus from what a text says and what the other text is saying also. Both ordinary and highlighted texts must come together at the same time to conform that kind of esthetic view that must be achieved as both messages advance together. This technique is particularly effective when writing very short interwritten pieces: ads, greetings cards, tweets:

Although there are different techniques to writing an Interwritten piece, in all cases, the highlighted text's message could be directly related or not to what the ordinary text is saying, but must not be the same: unnecessary repetitions should be avoided. If some portions in the ordinary text and in the highlighted text say the same, the context in which they are used in each text must be different. Readjustments must always be done to remain precise on what needs to be said for each text. In the cases where the highlighted text needs some words or punctuations that are not present in the ordinary text, the highlighted text may still use them, but in a “strikethrough parenthesis”: [symbol] [symbol] [symbol] [symbol] to indicate that they should not be read in the ordinary text:

And finally, in any interwritten piece, both, ordinary text and highlighted text, must properly communicate their intended messages. Revision must be done, going back and forth from one text to the other, for well achieved results. All needed syntactic and logic adjustments must be done to produce a strong ordinary text as well as a strong highlighted text. In all cases, managing properly the information between the ordinary text and the highlighted text can create amazing and unexpected written works.

### Two Short Stories include as Extra Samples of Interwritten Material

Interwriting is a tool that works, but one must use their own sensibility and talent to identify what to do with that tool. One must decide what story to write, what esthetic message to insert in each text, what contrast to seek. One of the two short stories I share below may get included in my upcoming book: “Recycling Words”, a collection of short stories that uses the interwriting technique in all its stories. The first story: Hunt of Hunters, was written, not from an existing text but from scratch. In this story the writer takes full control of the contents of both texts within the story. The story narrates a very intense tale that, from the ordinary text's final line, continues in its highlighted text into the inside of the ordinary text, showing an unexpected continuation of the events. And the second story takes its ordinary text from a fraction of one well-known Genesis Bible story. For the original text, just read the ordinary text, ignoring all strikethroughs, then read the highlighted text version, including any strikethrough content in its reading. This story was retiled: Moses and the Time Traveler. And now, as a final note, I want to add that the aspects set forth in the present description are efficiently attained and shall be interpreted not as limiting, but as illustrative of the spirit and scope of the invention.

What is claimed is:

1. A method wherein some of the words in a normal text, referred to as ordinary text, are selectively highlighted or otherwise signalized to build, with said words and without disrupting the ordinary text's content, one or more independent signalized texts, capable of creating and communicating additional information not contained in the ordinary text when just given a normal reading, but available when the signalized texts are read separately from the ordinary text that contains them; wherein a signalized text would be indicated either by a highlight, a bold, a different color or font of its letters or any similar signalization or combination of such that would allow its separate reading within the ordinary text; wherein grouping up portions of a highlighted text, one bellow the other, may give said portions a more unified look and would make their reading easier than if they were scattered all over the page; wherein a highlighted text can be written to be read either downward or upward, and when to be read upward, a signalized arrow pointing upward, under the last line of the ordinary text, may indicate it; wherein the highlighted text, if need it, may use its own words and punctuation marks, said words and punctuation marks should be inside a strikethrough parenthesis: to indicate that whatever is inside the parenthesis must be read only as part of the signalized text and not as part of the ordinary text.

2. The signalized or highlighted text of claim 1, which portions conform one orderly complete entity that communicates its own independent distinctive message without disrupting the message of the ordinary text that houses it; wherein the text's signalization can be indicated either through a highlight, an underlined, a bold, a different color or font of its words or any similar signalization or combination of such that would allow the text's separate reading from the ordinary text that contains it.

3. The method, according to claim 1, wherein, to convey its distinctive message, each signalized coherent highlighted text requires an independent reading from the ordinary text that houses it or them.

4. The method, according to claim 1, wherein a signalized text could be produced to be read downward or upward; wherein, said text to be read upward, a signalized text arrow pointing upward under the last line of the ordinary text may indicate it.

5. The method, according to claim 1, wherein, if needed, all signalized texts may use their own words and punctuation marks, to be ignored by the ordinary text that contain them; wherein said words and punctuation marks, inside a strikethrough parenthesis: would indicate that they must be read only as part of the signalized texts and ignore in an ordinary text's reading.
